(19) United States
(12) Patent Application Publication
(10) Pub. No.: US 2022/0088672 A1
(43) Pub. Date: Mar. 24, 2022

(54) PROCESS OF STRENGTHENING 3D PRINTED SAND CORE FOR THE CASTING OF INTEGRAL MULTI-WAY VALVE AND SAND CORE OF INTEGRAL HYDRAULIC MULTI-WAY VALVE

(71) Applicant: JIANGSU XCMG CONSTRUCTION MACHINERY RESEARCH INSTITUTE LTD., XUZHOU, Jiangsu (CN)

(72) Inventors: Bing HE, Jiangsu (CN); Fuxiang BO, Jiangsu (CN); Shuaitong WANG, Jiangsu (CN)

(21) Appl. No.: 17/425,598

(22) PCT Filed: Nov. 26, 2020
(86) PCT No.: PCT/CN2020/131661

§ 371 Date: Jul. 23, 2021

(30) Foreign Application Priority Data
Feb. 28, 2020 (CN) 202010126901.0

(51) Int. Cl. B22C 9/10; B33Y 10/00; B33Y 50/00; B33Y 80/00; B22C 9/24; B28B 1/00; B28B 17/00

(52) U.S. Cl. CPC B22C 9/10; B33Y 10/00; B33Y 50/00; B28B 17/0081; B22C 9/24; B28B 1/001; B33Y 80/00

(57) ABSTRACT

A process of strengthening 3D printed sand core for the casting of integral hydraulic multi-way valve and a sand core for integral hydraulic multi-way valve are provided. The process includes: creating a sand core model of a sand core for an integral hydraulic multi-way valve in three-dimensional software, analyzing parts of the sand core to determine a weak part of the sand core; designing a pore channel with a pore diameter and a length in the sand core model according to a ratio L/D of a length to a diameter of the weak part, and forming a reinforcing core bar according to the pore channel; and 3D printing the sand core according to the sand core model, placing the reinforcing core bar in the pore channel, and achieving tight connection of the reinforcing core bar and the sand core in the hardening or curing process of the sand core.

### CROSS REFERENCE TO RELATED APPLICATIONS

The present application is based on and claims the priority of Chinese Patent application No. 202010126901.0, filed on Feb. 28, 2020 and entitled “PROCESS OF STRENGTHENING 3D PRINTED SAND CORE FOR THE CASTING OF INTEGRAL MULTI-WAY VALVE”, the disclosure of which is incorporated herein by reference in its entirety.

### FIELD

The present disclosure belongs to the technical field of 3D printing equipment, and specifically relates to a process of strengthening 3D printed sand core for the casting of integral hydraulic multi-way valve and a sand core of integral hydraulic multi-way valve.

### BACKGROUND

At present, the manufacturing processes of a sand core of an integral hydraulic multi-way valve mainly include the traditional sand shooting process and the sand core 3D printing process, wherein the traditional sand shooting process requires establishment of moulds, so that the integral hydraulic multi-way valve is long in manufacturing cycle and high in cost; but as for the sand core 3D printing process, which is known for its short cycle and low cost, both the selective laser sintering process and the binder jetting process realize forming based on the powder spreading method, the loose characteristics of a printing powder layer result in that the compactness and strength of the printed sand core are lower than those of a sand core manufactured by the existing sand shooting process.

At the present stage, a 3D printed sand core can only meet the casting requirements for sand core of a simple part such as an engine cylinder block and a cylinder cover, a housing of hydraulic torque converter, and a plate-type valve. For integral hydraulic multi-way valve with complex inner oil passages, a 3D printed sand core of integral hydraulic multi-way valve includes a large number of cantilever sand core parts and elongated sand core parts. Such sand core parts are very easily deformed and even cracked under the actions of long-term baking and surrounding of molten iron, the buoyancy of the molten iron and their own thermal stress, which ultimately lead to casting failure.

In the process of finding the present disclosure, the inventor found that:

1. When the traditional mould establishing method is used for making a sand core of an integral multi-way valve, it is necessary to consider the draft taper and manufacture metal moulds, and this process greatly increases the development cycle and cost of new products. At the same time, inner flow passages of the multi-way valve are mostly relatively complicated, and it often needs to design inner flow passage sand core parts separately, leading to many subsequent sand core assembly processes and low accuracy of fit, which ultimately affect the quality of castings.
2. When the 3D printed sand core, especially the sand core parts, is designed by the existing method, the compactness and strength of the 3D printed sand core are both lower than that manufactured by the traditional sand shooting process as the apparent density of the precoated sand powder for 3D printing is lower than the density of a sand grain body. At the same time, the sand core designed based on the 3D printing process is an integrated whole sand core, the inconsistency of the sectional dimensions of various parts of the sand core will inevitably lead to uneven strength of the various parts. In the sand core, elongated sand core parts and cantilever sand core parts are weak points, but they are not reinforced in the existing process. Therefore, the weak parts of the 3D printed sand core often cannot withstand actions of the long-term baking of the molten iron, the buoyancy of the molten iron and their own thermal stress, resulting in the curved and even broken sand core in the casting process, and ultimately casting failure occurs.

### SUMMARY OF THE INVENTION

The technical solution used in the present disclosure is:

A process of strengthening 3D printed sand core for the casting of integral hydraulic multi-way valve, including:

creating a sand core model of a sand core to be 3D printed for an integral hydraulic multi-way valve in three-dimensional software, and then analyzing parts of the sand core to determine a weak part of the sand core;

with respect to the weak part of the sand core, designing a pore channel with a pore diameter and a length in the sand core model according to a ratio L/D of a length to a diameter of the weak part of the sand core, and forming a reinforcing core bar according to the pore channel with the pore the diameter and the length; and

3D printing the sand core according to the sand core model, placing the reinforcing core bar in the pore channel of the sand core, and achieving tight connection of the reinforcing core bar and the sand core in the hardening or curing process of the sand core, so that the strength of the sand core of the integral hydraulic multi-way valve is improved overall.

In some embodiments, wherein creating the sand core model of the sand core to be 3D printed for the integral hydraulic multi-way valve in three-dimensional software, and analyzing the parts of the sand core to determine the weak part of the sand core; the weak part of the sand core includes a main valve opening sand core part, an elongated sand core part or a cantilever hole sand core part.

In some embodiments, process of strengthening 3D printed sand core for the casting of integral hydraulic multi-way valve further includes: measuring the sectional diameter D and the length L of the weak part of the sand core in the sand core model, and calculating the ratio L/D of the length to the diameter.

In some embodiments, designing a pore channel with the pore diameter and the length in the sand core model according to the ratio L/D of the length to the diameter of the weak part of the sand core includes:

when the value of L/D of the weak part of the sand core is more than 6, creating a pore channel for placement of a reinforcing core bar in the sand core model, wherein the diameter of the pore channel is not less than 10% of the diameter of the weak part of the sand core and not more than 15% of the diameter of the weak part of the sand core, so as to ensure that the strength of the sand core is strengthened while breaking of the 3D printed sand core resulted from low initial strength is prevented in the post-processing process; at the same time, the pore channel extends to 5-10 mm inside a sand core main body, so that the reinforcing core bar is supported and fixed by the sand core main body; and a pore channel corresponding to a cantilever sand core does not completely penetrate a cantilever end, and penetrates a distance less than about 5 mm.

In some embodiments, the forming the reinforcing core bar according to the pore channel with the pore diameter and the length includes: according to the designed pore channel of the sand core, placing a steel pipe core bar for the main valve opening sand core part, wherein the sidewall of the steel pipe core bar is drilled with a plurality of air holes to assist conformal exhausting of a large-diameter weak part of the sand core in the pouring process, and the weak part of the sand core which is not the main valve opening sand core part (an elongated hole sand core part, a cantilever hole sand core part) uses a ceramic solid core bar.

In some embodiments, the 3D printing the sand core according to the sand core model, placing the reinforcing core bar in the pore channel of the sand core, and achieving tight connection of the reinforcing core bar and the sand core in the hardening or curing process of the sand core includes:

for a sand core printed by the binder forming process, after the printing is completed, immediately removing the sand core and cleaning the outer surface of the sand core and loose sand attached to the pore channel, then enabling a customized reinforcing core bar to penetrate into the pore channel of the sand core, and ultimately achieving tight connection of the sand core and the reinforcing core bar after the sand core is hardened;

or, for a sand core printed by the selective laser sintering process, placing the reinforcing core bar in the pore channel before heat curing of the sand core, and then achieving tight connection of the sand core and the reinforcing core bar in the heat curing process of the sand core.

According to a second aspect of the present disclosure, a sand core for an integral hydraulic multi-way valve is provided, formed by aforementioned process of strengthening 3D printed sand core for the casting of integral hydraulic multi-way valve.

### BRIEF DESCRIPTIONS OF THE DRAWINGS

FIG. 1 is a schematic diagram of a sand core of an integral hydraulic multi-way valve according to an embodiment of the present disclosure;

FIG. 2 is a schematic diagram of a main valve opening sand core part in FIG. 1;

FIG. 3 is a schematic diagram of an elongated hole sand core part in FIG. 1;

FIG. 4 is a schematic diagram of a cantilever sand core part in FIG. 1;

FIG. 5 is a schematic diagram of a steel pipe core bar for a sand core of an integral hydraulic multi-way valve according to an embodiment of the present disclosure;

FIG. 6 is a schematic diagram of a ceramic core bar for a sand core of an integral hydraulic multi-way valve according to an embodiment of the present disclosure.

### DETAILED DESCRIPTION OF THE EMBODIMENTS

The technical solutions in the embodiments of the present disclosure will be clearly and completely described below in conjunction with the accompanying drawings in the embodiments of the present invention. Apparently, the embodiments described are merely a part of the embodiments of the present disclosure, rather than all of the embodiments. The following description of at least one exemplary embodiment is actually merely illustrative, and in no way serves as any limitation to the present disclosure and its application or use. All other embodiments obtained by those of ordinary skill in the art based on the embodiments in the present disclosure without creative efforts fall within the protection scope of the present disclosure.

Unless otherwise specifically stated, the relative arrangement of components and steps, numerical expressions and numerical values set forth in these embodiments do not limit the scope of the present disclosure. At the same time, it should be understood that, for ease of description, the sizes of various parts shown in the drawings are not drawn to actual scale. The technologies, methods and equipment known to those of ordinary skill in related arts may not be discussed in detail, but where appropriate, the technologies, methods and equipment should be regarded as part of the granted specification. In all the examples shown and discussed herein, any specific value should be interpreted as merely exemplary, instead of limitation. Therefore, other examples of the exemplary embodiment may have different values. It should be noted that similar reference numerals and letters indicate similar items in the following drawings, so that once an item is defined in one drawing, it does not need to be further discussed in the subsequent drawings.

The embodiment of the present disclosure provides a process of strengthening 3D printed sand core for the casting of integral multi-way valve, including the following steps:

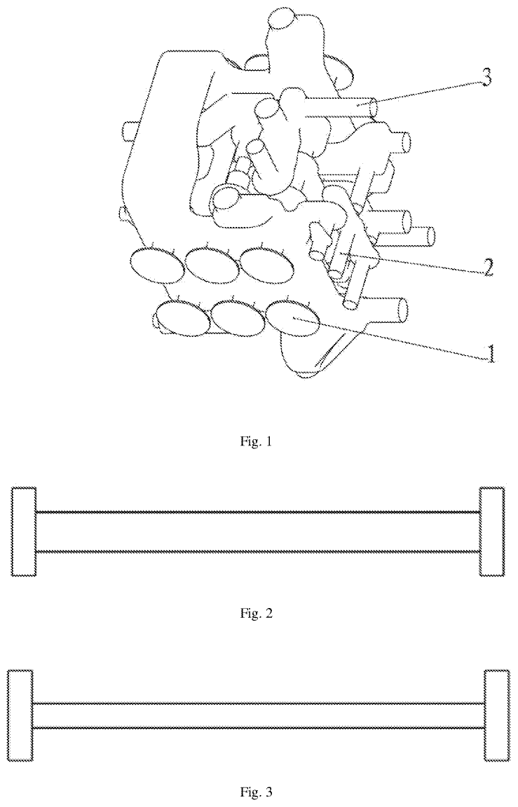

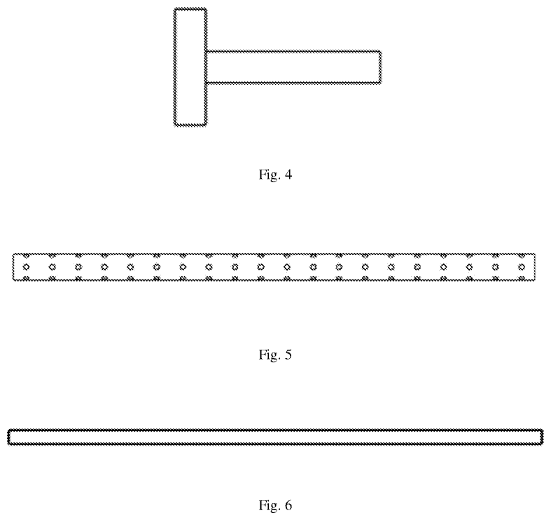

Step 1, a sand core model of a sand core to be 3D printed for an integral hydraulic multi-way valve is created in three-dimensional software, as shown in FIG. 1, then parts of the sand core are analyzed to determine a weak part of the sand core, such as a main valve opening sand core part 1, an elongated hole sand core part 2, or a cantilever hole sand core part 3; FIG. 2 is a schematic diagram of a main valve opening sand core part in FIG. 1; FIG. 3 is a schematic diagram of an elongated hole sand core part in FIG. 1; FIG. 4 is a schematic diagram of a cantilever sand core part in FIG. 1.

Step 2, a sectional diameters D and a lengths L of the weak part of the sand core including the main valve opening sand core part 1, the elongated hole sand core part 2 or the cantilever hole sand core part 3 as determined in step 1 are measured, and the ratios L/D of the length to the diameter is calculated.

Step 3, according to the calculated result of weak part of the sand core in step 2, when the value of L/D is more than 6, a pore channel for placement of a reinforcing core bar is created in the sand core model, the diameter of the pore channel is not less than 10% of the diameter of the weak part of the sand core and not more than 15% of the diameter of the weak part of the sand core, so as to ensure that the strength of the sand core is strengthened while breaking of the 3D printed sand core resulted from low initial strength is prevented in the post-processing process. At the same time, the pore channel extends to 5-10 mm inside a sand core main body, so that the reinforcing core bar can be supported and fixed by the sand core main body, and specifically, the pore channel corresponding to the cantilever sand core part cannot completely penetrate a cantilever end, and penetrate a distance less than about 5 mm.

Step 4, according to the pore channel of the sand core determined in step 3, a steel pipe core bar should be preferably used for the main valve opening sand core part or other large-diameter sand core part, wherein the sidewall of the steel pipe core bar is drilled with a plurality of air holes to assist conformal exhausting of large-diameter sand core part in the pouring process, and other sand core (an elongated hole sand core part 2 or a cantilever hole sand core part 3) use ceramic solid core bar. FIG. 5 is a schematic diagram of a steel pipe core bar for a sand core of an integral hydraulic multi-way valve according to an embodiment; FIG. 6 is a schematic diagram of a ceramic core bar for a sand core of an integral hydraulic multi-way valve according to an embodiment; and inner holes of the reinforcing core bar and the pore channel of the sand core jointly play a role of conformal exhausting of the sand core.

Step 5, for a sand core printed by the binder forming process, after the printing is completed, it is necessary to immediately remove the sand core and clean the outer surface of the sand core and loose sand attached to the pore channel, then a customized reinforcing core bar penetrates into the pore channel of the sand core, and ultimately tight connection of the sand core and the reinforcing core bar is achieved after the sand core is hardened; and for a sand core printed by the selective laser sintering process, a reinforcing core bar is placed in the pore channel before heat curing of the sand core, and then tight connection of the sand core and the reinforcing core bar is achieved in the heat curing process of the sand core.

The process of strengthening 3D printed sand core for the casting of integral hydraulic multi-way valve provided by the present disclosure has at least one of the following beneficial effects:

In the process of strengthening 3D printed sand core for the casting of integral hydraulic multi-way valve provided by the present disclosure, after the three-dimensional model of the sand core to be printed for the integral hydraulic multi-way valve is established, the pore channel with the pore diameter and the length are designed in the sand core model with respect to the weak part of the sand core such as the cantilever sand core part, the elongated hole sand core part and the main valve opening sand core part, and after 3D printing of the sand core is completed, the reinforcing core bar is formed according to the pore channel with the pore diameter and the length and disposed in the pore channel of the sand core in advance, so that the strength of the sand core of the integral hydraulic multi-way valve is improved overall to achieve the sand core strength required for casting of the integral hydraulic multi-way valve, and improve the success rate of rapid casting the integrated hydraulic multi-way valve using the 3D printed sand core. The following advantages are provided:

1. Reinforced sand core. The apparent density of precoated sand powder for 3D printing is lower than the density of the sand grain body, and the compactness and strength of the printed sand core cannot withstand actions of the long-term baking of the molten iron, the buoyancy of the molten iron, and their own thermal stress, resulting in that curved and broken sand core often occur in the casting process. In the present disclosure, high-strength core bar is disposed for the 3D printed sand core in advance to reinforce the weak part of the sand core, which not only reduces the breaking risk in intermediate links such as sand core transfer and flow painting, but also improves the high temperature resistance of the sand core in the casting process.
2. Conformal exhausting. The prefabricated pore channel for the sand core of the integral hydraulic multi-way valve not only plays a role of placing the reinforcing core bar, but also is conductive to the conformal exhausting of the sand core in the pouring process.
3. High casting success rate of integral hydraulic multi-way valve. High-strength core bar is disposed at the weak part of the sand core of the integral hydraulic multi-way valve in advance, so that the overall strength of the sand core is effectively improved, and the buoyancy of the molten iron and the thermal stress of the sand core are mostly transferred to the reinforcing core bar in the casting process and ultimately transferred to the sand core main body, which alleviates the breaking risk of the sand core, and finally effectively improves the casting success rate of the integral hydraulic multi-way valve.

The above description is merely preferred embodiments of the present disclosure. It should be noted that various improvements and modifications may also be made for those of ordinary skill in the art without departing from the principles of the present invention, and these improvements and modifications also should be contemplated as being within the protection scope of the present disclosure.

1. A process of strengthening 3D printed sand core for the casting of integral hydraulic multi-way valve, comprising:
creating a sand core model of a sand core to be 3D printed for an integral hydraulic multi-way valve in three-dimensional software, and then analyzing parts of the sand core to determine a weak part of the sand core;
with respect to the weak part of the sand core, designing a pore channel with a pore diameter and a length in the sand core model according to a ratio L/D of a length to a diameter of the weak part of the sand core, and forming a reinforcing core bar according to the pore channel with the pore diameter and the length; and
3D printing the sand core according to the sand core model, placing the reinforcing core bar in the pore channel of the sand core, and achieving tight connection of the reinforcing core bar and the sand core in the hardening or curing process of the sand core, so that the strength of the sand core of the integral hydraulic multi-way valve is improved overall.

2. The process of strengthening 3D printed sand core for the casting of integral hydraulic multi-way valve according to claim 1, wherein creating the sand core model of the sand core to be 3D printed for the integral hydraulic multi-way valve in three-dimensional software, and analyzing the parts of the sand core to determine the weak part of the sand core; and the weak part of the sand core comprise a main valve opening sand core part, an elongated sand core part or a cantilever hole sand core part.

3. The process of strengthening 3D printed sand core for the casting of integral hydraulic multi-way valve according to claim 1, further comprising: measuring the sectional diameter D and the length L of the weak part of the sand core in the sand core model, and calculating the ratio L/D of the length to the diameter.

4. The process of strengthening 3D printed sand core for the casting of integral hydraulic multi-way valve according to claim 3, wherein the designing the pore channel with the pore diameter and the length in the sand core model according to the ratio L/D of the length to the diameter of the weak part of the sand core comprises:
when the value of L/D of the weak part of the sand core is more than 6, creating a pore channel for placement of a reinforcing core bar in the sand core model, wherein the diameter of the pore channel is not less than 10% of the diameter of the weak part of the sand core and not more than 15% of the diameter of the weak part of the sand core, so as to ensure that the strength of the sand core is strengthened while breaking of the 3D printed sand core resulted from low initial strength is prevented in the post-processing process; at the same time, the pore channel extends to 5-10 mm inside a sand core main body, so that the reinforcing core bar is supported and fixed by the sand core main body; and a pore channel corresponding to a cantilever sand core does not completely penetrate a cantilever end, and penetrates a distance less than about 5 mm.

5. The process of strengthening 3D printed sand core for the casting of integral hydraulic multi-way valve according to claim 1, wherein forming the reinforcing core bar according to the pore channel with the pore diameter and the length comprises: according to the designed pore channel of the sand core, placing a steel pipe core bar in a main valve opening sand core part, wherein the sidewall of the steel pipe core bar is drilled with a plurality of air holes to assist conformal exhausting of a large-diameter weak part of the sand core in the pouring process, and the weak part of the sand core which is not the main valve opening sand core part uses a ceramic solid core bar.

6. The process of strengthening 3D printed sand core for the casting of integral hydraulic multi-way valve according to claim 1, wherein 3D printing the sand core according to the sand core model, placing the reinforcing core bar in the pore channel of the sand core, and achieving tight connection of the reinforcing core bar and the sand core in the hardening or curing process of the sand core comprises:
for a sand core printed by the binder forming process, after the printing is completed, removing the sand core and cleaning the outer surface of the sand core and loose sand attached to the pore channel, then enabling a customized reinforcing core bar to penetrate into the pore channel of the sand core, and ultimately achieving tight combination of the sand core and the reinforcing core bar after the sand core is hardened; or
for a sand core printed by the selective laser sintering process, placing the reinforcing core bar in the pore channel before heat curing of the sand core, and then achieving tight connection of the sand core and the reinforcing core bar in the heat curing process of the sand core.

7. A sand core for integral hydraulic multi-way valve, formed by the process of strengthening 3D printed sand core for the casting of integral hydraulic multi-way valve according to claim 1.
